(19) United States
(12) Patent Application Publication
(10) Pub. No.: US 2013/0130068 A1
(43) Pub. Date: May 23, 2013

(54) BATTERY SYSTEM, METHOD OF CONTROLLING THE BATTERY SYSTEM, AND ENERGY STORAGE SYSTEM INCLUDING THE SAME

(71) Applicants: Byung-Il Song, Yongin-si (KR); Jong-Woon Yang, Yongin-si (KR)

(72) Inventors: Byung-Il Song, Yongin-si (KR); Jong-Woon Yang, Yongin-si (KR)

(73) Assignee: SAMSUNG SDI Co., Ltd., Yongin-si (KR)

(21) Appl. No.: 13/564,901

(22) Filed: Aug. 2, 2012

(30) Foreign Application Priority Data
Nov. 17, 2011 (KR) 10-2011-0120347

(51) Int. Cl. H01M 2/00

(52) U.S. Cl. 429/50; 429/61

(57) ABSTRACT

A battery system, a method of controlling the battery system, and an energy storage system including the battery system. The battery system includes: a plurality of tray battery management systems (BMSs) controlling at least one battery tray formed of a plurality of battery cells; and a rack BMS transmitting a synchronization signal to the tray BMSs to measure monitoring data, wherein the tray BMSs transmit the synchronization signal to a next tray BMS, measure monitoring data of the at least one battery tray via the transmitted synchronization signal, and transmit the measured monitoring data to the rack BMS. Accordingly, measurement accuracy of battery voltages and battery charging/discharging currents may be improved, and also, calculation accuracy of state of charge (SOC) and state of health (SOH) may be improved.

### CLAIM PRIORITY

This application makes reference to, incorporates the same herein, and claims all benefits accruing under 35 U.S.C. §119 from an application earlier filed in the Korean Intellectual Property Office on 17 Nov. 2011 and there duly assigned Serial No. 10-2011-0120347.

### BACKGROUND OF THE INVENTION

1. Field of the Invention

One or more embodiments of the present invention generally relates to battery systems, methods of controlling the battery systems, and energy systems including the battery systems.

2. Description of the Related Art

As problems, such as environmental contamination and resource exhaustion, increase, interest in systems for storing energy and efficiently using the stored energy also increases. There is also increased interest in renewable energy that does not cause pollution during power generation. Thus, research into energy storage systems, which may be used with renewable energy, a power storage battery system, and existing grid power, has been actively conducted as changes occur in today's environment.

The above information disclosed in this Related Art section is only for enhancement of understanding of the background of the invention and therefore it may contain information that does not form the prior art that is already known to a person of ordinary skill in the art.

### SUMMARY OF THE INVENTION

One or more embodiments of the present invention may include battery systems for which measurement accuracy of battery voltages and battery charging/discharging currents may be improved, methods of controlling the battery systems, and power storage systems including the battery systems.

Additional aspects will be set forth in part in the description which follows and, in part, will be apparent from the description, or may be learned by practice of the presented embodiments.

According to one or more embodiments of the present invention, a battery system may include a number of tray battery management systems (BMSs) controlling at least one battery tray formed of a plurality of battery cells. Further, a rack BMS transmitting a synchronization signal to the tray BMSs to measure monitoring data may be included in which the tray BMSs transmit the synchronization signal to a next tray BMS, measure monitoring data of the at least one battery tray via the transmitted synchronization signal, and transmit the measured monitoring data to the rack BMS.

The monitoring data may be related to one selected from the group including a voltage, a current, a temperature, a remaining amount of power, a lifetime, and a state of charge of the at least one battery tray.

The tray BMSs may transmit the measured monitoring data to the rack BMS at predetermined time intervals.

Each of the tray BMSs may include: a switching unit that transmits the synchronization signal to a next tray BMS after receiving the synchronization signal; a measuring unit that measures monitoring data of the at least one battery tray in synchronization with the received synchronization signal; and a communication unit that transmits the measured monitoring data to the rack BMS.

The switching unit may be a photo-coupler.

The rack BMS may measure a charging/discharging current while the tray BMSs measure monitoring data of the at least one battery tray.

The tray BMSs and the rack BMS may perform controller area network (CAN) communication.

According to one or more embodiments of the present invention, a method of controlling a battery system including a number of tray battery management systems (BMSs) controlling a number of battery trays formed of a number of battery cells; and a rack BMS controlling the number of tray BMSs, includes: transmitting, by the rack BMS, a synchronization signal the tray BMSs to measure monitoring data; measuring, by the tray BMSs that have received the synchronization signal, monitoring data of the number of battery trays; and transmitting the measured monitoring data to the rack BMS.

The monitoring data may be related to one selected from the group including a voltage, a current, a temperature, a remaining amount of power, a lifetime, and a state of charge of the plurality of battery trays.

In the transmitting of the synchronization signal, after a first tray BMS has received the synchronization signal, the synchronization signal may be transmitted to a next tray BMS.

The transmitting of the synchronization signal may be performed by using a photo-coupler.

In the measuring monitoring data, while the tray BMSs measure monitoring data, the rack BMS may measure a charging/discharging current.

In the transmitting of the monitoring data to the rack BMS, the tray BMSs may transmit the measured monitoring data to the rack. BMS at predetermined time intervals.

The tray BMSs and the rack BMS may perform controller area network (CAN) communication.

According to one or more embodiments of the present invention, an energy storage system including a battery system includes: at least one tray battery management system (BMS) controlling at least one battery tray formed of a number of battery cells; and a rack BMS controlling the at least one tray BMS, and supplying power to a load by connecting power of the battery system, a generation system, and a grid, wherein the tray BMS transmits a synchronization signal to a next tray BMS; measures monitoring data of the at least one battery tray via the transmitted synchronization signal; and transmits the measured monitoring data to the rack BMS.

The monitoring data may be related to one selected from the group including a voltage, a current, a temperature, a remaining amount of power, a lifetime, and a state of charge (SOC) of the at least one battery tray.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of an energy storage system according to an embodiment of the present invention;

FIG. 2 is a block diagram of a battery system according to an embodiment of the present invention;

FIG. 3 is a block diagram of a battery rack according to an embodiment of the present invention;

FIG. 4 is a block diagram illustrating a battery rack and a rack management unit according to an embodiment of the present invention;

FIG. 5 is a timing diagram of communication between a tray management unit and a rack management unit illustrated in FIG. 4; and

FIG. 6 is a flowchart illustrating a method of controlling a battery system according to an embodiment of the present invention.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention. While such terms as “first,” “second,” etc., may be used to describe various components, such components must not be limited to the above terms. The above terms are used only to distinguish one component from another.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The embodiments of the present invention will be described below in more detail with reference to the accompanying drawings. Those components that are the same or are in correspondence are rendered the same reference numeral regardless of the figure number, and redundant explanations are omitted.

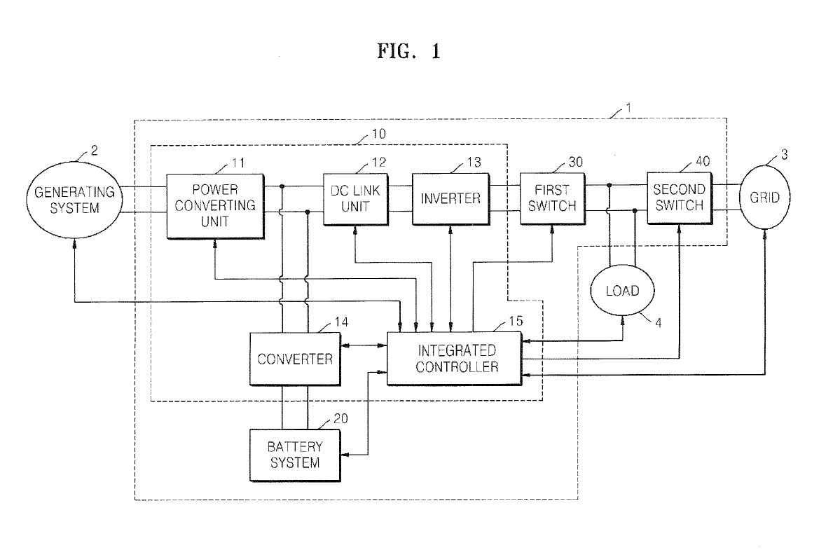

FIG. 1 is a block diagram of an energy storage system 1 according to an embodiment of the present invention.

Referring to FIG. 1, the energy storage system 1 may supply power to a load 4 by being connected to a generation system 2 and a grid 3.

The generation system 2 is a system that generates power by using an energy source. The generation system 2 supplies the generated power to the energy storage system 1. The generation system 2 may be a solar generation system, a wind generation system, or a tidal generation system. However, the present embodiment is not limited thereto, and the generation system 2 may be any generation system that may generate power by using renewable energy such as solar heat or geothermal heat. In particular, a solar cell for generating electrical energy by using sunlight may be applied to the energy storage system 1, which may be distributed in houses and factories because it is easy to install the solar cell therein. The generation system 2 may act as a high-capacity energy system by generating power by using a plurality of power generation modules that may be arranged in parallel.

The grid 3 may include a power plant, a substation, power lines, and the like. If the grid 3 is in a normal state, the grid 3 supplies power to the energy storage system 1 which in turn may be supplied to the power to the load 4 and/or a battery system 20, and receives power supplied from the energy storage system 1. If the grid 3 is in an abnormal state, the grid 3 does not supply power to the energy storage system 1, and the energy storage system 1 stops supplying power to the grid 3.

The load 4 may either consume power generated by the generation system 2, power stored in the battery system 20, or power supplied from the grid 3. A house or a factory may be an example of the load 4.

The energy storage system 1 may store power generated by the generation system 2 in the battery system 20, and may send the generated power to the grid 3. The energy storage system 1 may supply power stored in the battery system 20 to the grid 3, or store power supplied from the grid 3 in the battery system 20. In an abnormal situation, for example, if there is a power failure in the grid 3, the energy storage system 1 may supply power to the load 4 by performing an uninterruptible power supply (UPS) operation. Even if the grid 3 is in a normal state, the energy storage system 1 may supply power generated by the generation system 2 or power stored in the battery system 20 to the load 4.

The energy storage system 1 may include a power conversion system (PCS) 10 that controls power conversion, the battery system 20, a first switch 30, a second switch 40, etc.

The PCS 10 converts power of the generation system 2, the grid 3, and the battery system 20 into suitable power and supplies the converted power to where needed. The PCS 10 may include a power converting unit 11, a direct current (DC) link unit 12, an inverter 13, a converter 14, and an integrated controller 15.

The power converting unit 11 may be connected between the generation system 2 and the DC link unit 12, and delivers power generated by the generation system 2 to the DC link unit 12. At this time, an output voltage of power output from the power converting unit 11 may be converted into a DC link voltage.

The power converting unit 11 may include a power conversion circuit, such as a converter, a rectifier circuit, etc. according to the type of the generation system 2. More specifically, if the generation system 2 generates DC power, the power converting unit 11 may include a converter for converting the DC power to DC power. On the contrary, if the generation system 2 generates alternating current (AC) power, the power converting unit 11 may include a rectifier circuit for converting the AC power to DC power. In particular, if the generation system 2 is a solar generation system, the power converting unit 11 may include a maximum power point tracking (MPPT) converter so as to obtain maximum power output from the generation system 2 according to a change in solar radiation, temperature, or the like. When the generation system 2 generates no power, the power converting unit 11 may stop operating and minimize power consumption of a converter included in the power converting unit 11 or the like.

A level of the DC link voltage may become unstable due to an instantaneous voltage drop of the generation system 2 or the grid 3 or a peak load occurrence in the load 4. However, the DC link voltage needs to be stabilized to normally operate the inverter 13 and the converter 14. The DC link unit 20 may be connected between the power converting unit 11 and the inverter 13 and maintains the DC link voltage. The DC link unit 12 may be realized by, for example, a mass storage capacitor, etc.

The inverter 13 may be a power converter connected between the DC link unit 12 and the first switch 30. The inverter 13 may include an inverter that converts the DC link voltage output from the generation system 2 and/or the battery system 20 into an alternating current (AC) voltage of the grid 3 and outputs the AC voltage in a discharging mode. The inverter 13 may include a rectifier circuit that rectifies an. AC voltage output from the grid 3 into the DC link voltage to be stored in the battery system 20 in a charging mode. That is, the inverter 13 may be a bidirectional inverter in which directions of input and output are changeable.

The inverter 13 may include a filter for removing harmonics from the AC voltage output to the grid 3, and a phase-locked loop (PLL) circuit for matching a phase of the AC voltage output from the inverter 13 to a phase of the AC voltage of the grid 3 in order to prevent generation of reactive power. Also, the inverter 13 may perform other functions such as restriction of voltage variation range, power factor correction, removal of DC components, and protection of transient phenomenon. When the inverter 30 is not used, the operation of the inverter 13 may be stopped so as to minimize power consumption.

The converter 14 may be a power converter that may be connected between the DC link unit 12 and the battery system 20. The converter 14 may include a converter that performs DC-DC conversion by converting a voltage of power output from the battery system 20 into a voltage level, i.e., the DC link voltage that is required by the inverter 13 in a discharge mode.

The converter 14 may include a converter that performs DC-DC conversion by converting a voltage of power output from the power converting unit 11 or the inverter 13 into a voltage level, i.e., a charge voltage required by the battery system 20 in a charge mode. That is, the converter 14 may be a bidirectional converter in which directions of input and output are changeable. The converter 14 may stop an operation thereof and minimize power consumption thereof when there is no need to charge or discharge the battery system 20.

The integrated controller 15 monitors the states of the generation system 2, the grid 3, the battery system 20, and the load 4, and controls the power converting unit 11, the inverter 13, the converter 14, the battery system 20, the first switch 30, and the second switch 40 according to results of the monitoring. The integrated controller 15 may monitor whether a power failure occurs in the grid 3, whether the generation system 2 generates power, an amount of power generated by the generation system 2, a charge state of the battery system 20, an amount of power consumed by the load 4, time, and the like. If power to be supplied to the load 4 is insufficient like the power failure occurs in the grid 3, the integrated controller 15 may control the load 4 to determine priorities for devices which use power included in the load 4 and supply power to the devices which use power having high priorities.

The first switch 30 and the second switch 40 are connected in series between the inverter 13 and the grid 3, and control the flow of current between the generation system 2 and the grid 3 by being turned on or off under the control of the integrated controller 15. The first switch 30 and the second switch 40 may be turned on or off according to states of the generation system 2, the grid 3, and the battery system 20.

More specifically, if power of the generation system 2 and/or the battery system 20 may be supplied to the load 4 or power of the grid 3 may be supplied to the battery system 20, the first switch 30 is turned on. If power of the generation system 2 and/or the battery system 20 may be supplied to the grid 3 or power of the grid 3 may be supplied to the load 4 and/or the battery system 20, the second switch 40 is turned on.

Meanwhile, if there is a power failure in the grid 3, the second switch 40 may be turned off and the first switch 30 may be turned on. Accordingly, power from the generation system 2 and/or the battery system 20 may be supplied to the load 4, but may not flow into the grid 3, which prevents the energy storage system 1 from operating solely, thereby preventing a worker who works at a power distribution line of the grid 3 or the like from getting an electric shock due to the power of the energy storage system 1.

Switching devices like relays capable of enduring a large current may be used as the first switch 30 and the second switch 40.

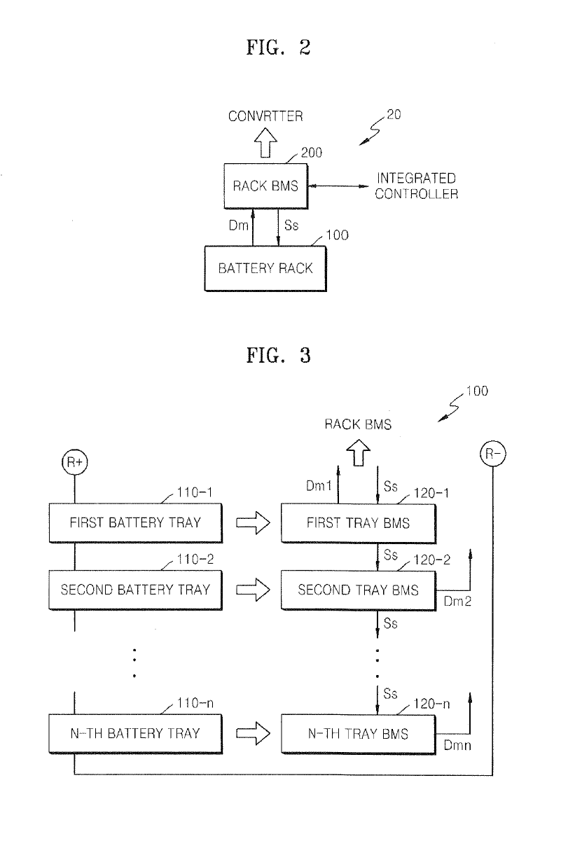

The battery system 20 receives and stores power generated by the generation system 2 and/or power output from the grid 3, and supplies power stored to the load 4 or the grid 3. The battery system 20 may include a portion for storing power and a portion for controlling and protecting the portion for storing power. Hereinafter, the construction of the battery system 20 will be described in detail with reference to FIG. 2.

FIG. 2 is a block diagram of a battery system 20 according to an embodiment of the present invention.

Referring to FIG. 2, the battery system 20 may include a battery rack 100 and a rack battery management system (BMS) 200.

The battery rack 100 stores power supplied from the generation system 2 and/or the grid 3, and supplies the stored power to the generation system 2 and/or the grid 3. The battery rack 100 may include a plurality of subunits, which will be described in detail with reference to FIG. 3.

FIG. 3 is a block diagram of a battery rack 100 according to an embodiment of the present invention.

Referring to FIG. 3, the battery rack 100 may include at least one battery tray, that is, a first battery tray 110-1 through an n-th battery tray 110-n that are connected to each other in series and/or in parallel as subunits. Each of the battery trays 110-1, 110-n may include a plurality of battery cells as subunits. The battery cells may use various rechargeable secondary batteries. For example, secondary batteries used in the battery cells include a nickel-cadmium battery, a lead acid battery, a nickel metal hydride (NiMH) battery, a lithium ion battery, a lithium polymer battery, or the like.

The battery rack 100 may control a desired output according to how the first through n-th battery trays 110-1, . . . 110-n are connected, and outputs power through a positive output terminal R+ and a negative output terminal R−.

The battery rack 100 may include a first tray BMS 120-1 through an n-th tray BMS 120-n respectively corresponding to the first through n-th battery trays 110-1 through 110-n. At least one BMS tray, that is, the first through n-th tray BMSs 120-1, . . . 120-n receive a synchronization signal Ss from the rack BMS 200 and monitor voltages, current, temperatures, etc. of the respectively corresponding battery trays 110-1, . . . 110-n. The first through n-th tray BMSs 120-1 through 120-n may transmit results of the monitoring to the rack BMS 200 at predetermined intervals.

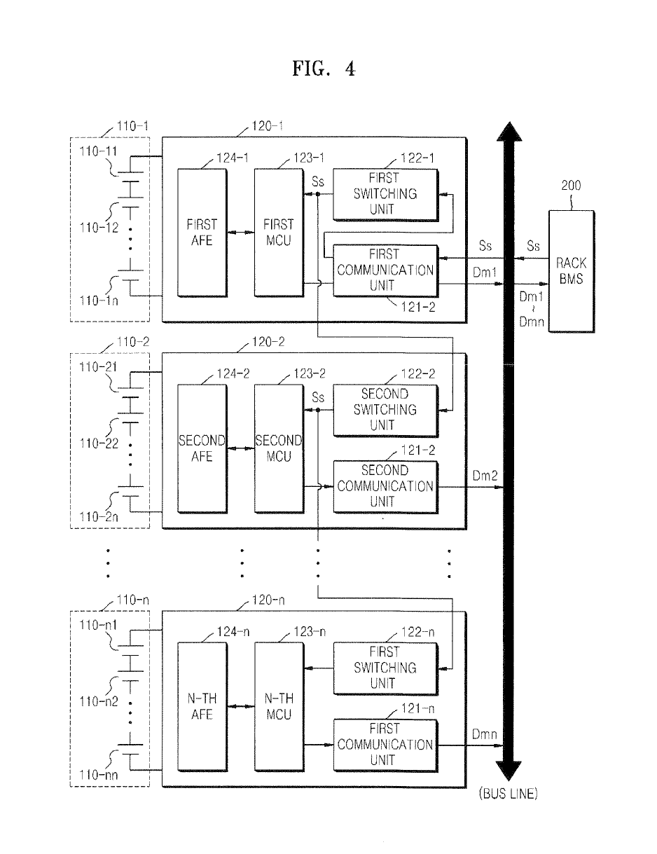

Referring to FIG. 2, the rack BMS 200 may be connected to the battery rack 100 and controls charging and discharging operations of the battery rack 100. The rack BMS 200 may perform overcharge protection, over-discharge protection, over-current protection, overvoltage protection, overheat protection, cell balancing, etc. To this end, the rack BMS 200 may transmit a synchronization signal Ss to the battery rack 100 and receive monitoring data Dm regarding a voltage, a current, a temperature, a remaining amount of power, a lifetime, a state of charge, etc. from the first through n-th tray BMSs 120-1 through 120-n. Also, the rack BMS 200 may apply the received monitoring data Dm to the integrated controller 15, and receive a command relating to control of the battery rack 100 from the integrated controller 15. Hereinafter, the battery rack 100 and the rack BMS 200 will be described in detail with reference to FIG. 4.

FIG. 4 is a block diagram illustrating the battery rack 100 and the rack BMS 200 according to an embodiment of the present invention.

Referring to FIG. 4, the first through n-th tray BMSs 120-1 through 120-n may include a communication unit (first through n-th communication units 121-1 through 121-n), a switching unit (first through n-th switching units 122-1 through 122-n), a micro-controller unit (MCU) (first through n-th MCUs), and an analog front end (AFE) (first through n-th AFEs 124-1 through 124-n).

The first communication unit 121-1 of the first tray BMS 120-1 receives a synchronization signal Ss from the rack BMS 200. The rack BMS 200 and the first through n-th tray BMSs 120-1 through 120-n are connected via a bus line and perform two-way data communication, but data communication using other various methods are also possible. For example, a controller area network (CAN) communication protocol may be used as a communication method between the rack BMS 200 and the tray BMSs 120-1 through 120-n. However, the communication method is not limited thereto, and various communication methods using a bus line may be used. Moreover, communication methods not using a bus line may also be used.

Upon receiving the synchronization signal Ss from the first communication unit 121-1, the first switching unit 122-1 may be turned on. The switching unit may be a photo-coupler. When the first switching unit 122-1 is turned on, the synchronization signal Ss may be transmitted to the first MCU 123-1, and at the same time, the second switching unit 122-2 of the second tray BMS 120-2 may be turned on. When the second switching unit 122-2 is turned on, the synchronization signal Ss may be transmitted to the second MCU 123-2, and at the same time, a third switching unit (not shown) of a third tray BMS (not shown) may be turned on. As can be seen here, the first switching unit 122-1 through the n-th switching unit 122-n are serially connected. As the first switching unit 122-1 through the n-th switching unit 122-n are serially connected, a time difference may be generated in turn-on time, but the difference is negligibly small.

The first through n-th MCUs 123-1 through 123-n that have received the synchronization signal Ss transmitted by using the rack BMS 200 control the first through n-th AFEs 124-1 through 124-n such that the first through n-th AFEs 124-1 through 124-n measure a voltage, a current, a temperature, a remaining amount of power, a lifetime, and a state of charge, etc. of the first through n-th battery trays 110-1 through 110-n. Here, the first through n-th AFEs 124-1 through 124-n may simultaneously measure monitoring data Dm. Also, while the first through n-th AFEs 124-1 through 124-n measure monitoring data Dm, the rack BMS 200 may measure charging/discharging currents.

When measurement of monitoring data Dm is completed, the first through n-th AFEs 124-1 through 124-n convert measured data to digital data. Then, after a predetermined period of time, for example, after about 50 ms has elapsed, the first MCU 123-1 of the first tray BMS 120-1 transmits first monitoring data Dm1 to the rack BMS 200 via the first communication unit 121-1. Here, the rest of tray BMSs (the second through n-th tray BMS 120-2 through 120-n) do not transmit monitoring data Dm but remain on standby.

When transmission of the first monitoring data Dm1 is completed, the second MCU 123-2 of the second tray BMS 120-2 transmits second monitoring data Dm2 to the rack BMS 200 via the second communication unit 121-2. An interval of transmission between the first monitoring data Dm1 and the second monitoring data Dm2 may be, for example, 12 ms. That is, 12 ms after the first monitoring data Dm1 is transmitted, the second monitoring data Dm2 may be transmitted. The monitoring data Dm may be transmitted up to n-th monitoring data Dmn at an interval as described above.

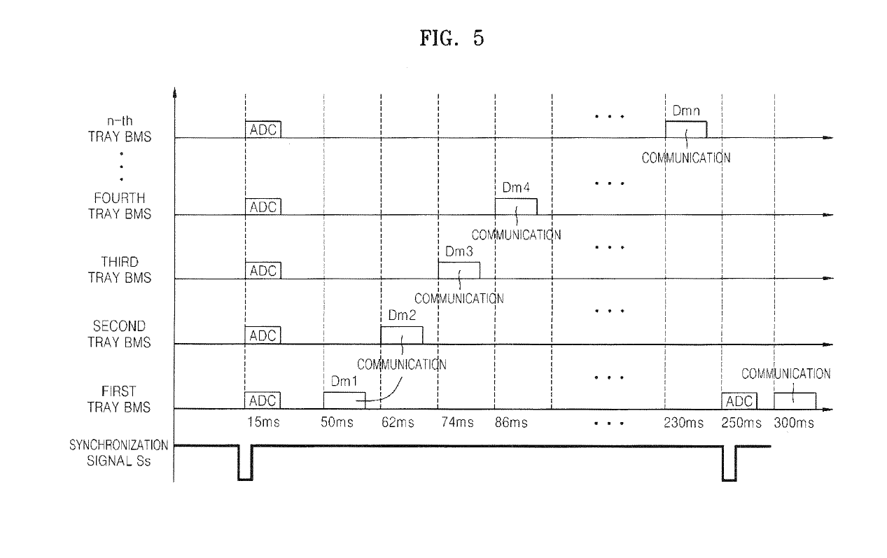

FIG. 5 is a timing diagram of communication between the tray BMS 120 and the rack BMS 200 illustrated in FIG. 4.

After the synchronization signal Ss is transmitted to the first through n-th tray BMSs 120-1 through 120-n from the rack BMS 200, and the measured monitoring data Dm may be converted to digital data by the first through n-th AFEs 124-1 through 124-n, the first monitoring data Dm 1 through the n-th monitoring data Dmn are sequentially transmitted from the first through n-th tray BMSs 120-1 through 120-n at intervals of, for example, 12 ms.

Accuracy of measurement of battery voltages and battery charging/discharging currents may be improved by transmission of the synchronization signal Ss and reception of the first through n-th monitoring data Dm1 through Dmn by using communication between the first through n-th tray BMSs 120-1 through 120-n and the rack BMS 200, and also, accuracy of calculation of state of charge (SOC) and state of health (SOH) may be improved.

In addition, when respectively applying the synchronization signal Ss directly to the first through n-th tray BMS 120-1 through 120-n, a tray BMS that is far away from the rack BMS 200, for example, the n-th tray BMS 120-n, may not recognize the synchronization signal Ss due to a decrease in voltage caused in a data line. However, as the first through n-th tray BMSs 120-1 through 120-n are serially connected and the synchronization signal Ss may be sequentially applied, reliability of the simultaneous application of the synchronization signal Ss and the monitoring data Dm may be improved.

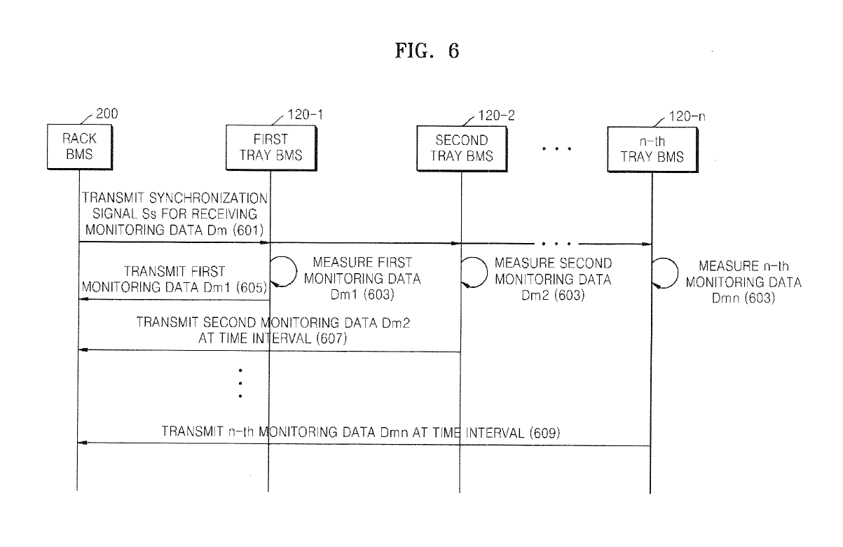

FIG. 6 is a flowchart illustrating a method of controlling a battery system according to an embodiment of the present invention.

Referring to FIG. 6, in operation 601, the rack BMS 200 transmits a synchronization signal Ss to the first through n-th tray BMSs 120-1 through 120-n to receive monitoring data Dm.

Here, the rack BMS 200 and the first through n-th tray BMSs 120-1 through 120-n are connected via a bus line and perform two-way data communication, but the communication method is not limited thereto. For example, a CAN communication protocol may be used as a communication method between the rack BMS 200 and the first through n-th tray BMSs 120-1 through 120-n. However, the communication method is not limited thereto, and other various communication methods using a bus line may be used. Moreover, communication methods not using a bus line may also be used.

The monitoring data Dm may correspond to a voltage, a current, a temperature, a remaining amount of power, a lifetime, and a state of charge, etc. of the first through n-th battery trays 110-1 through 110-n.

The first through n-th switching units 122-1 through 122-n are included in the first through n-th battery trays 110-1 through 110-n, respectively. Upon receiving a synchronization signal Ss, the first through n-th switching units 122-1 through 122-n are turned-on by switching. The switching unit may be a photo-coupler. The first through n-th switching units 122-1 through 122-n may be photo-couplers. When the first switching unit 122-1 is turned on, the synchronization signal Ss may be transmitted to the first MCU 123-1, and at the same time, the second switching unit 122-2 of the second tray BMS 120-2 may be turned-on by switching. When the second switching unit 122-2 is turned on, the synchronization signal Ss is transmitted to the second MCU 123-2, and at the same time, the third switching unit (not shown) of the third tray BMS (not shown) may be turned on by switching. As can be seen from this, the first switching unit 122-1 through the n-th switching unit 122-n are serially connected. As the first switching unit 122-1 through the n-th switching unit 122-n are serially connected, a time difference may be generated in turn-on time, but the difference is negligibly small.

In operation 603, the first through n-th MCUs 123-1 through 123-n that have received the synchronization signal Ss control the first through n-th AFH 124-1 through 124-n such that the first through n-th AFEs 124-1 through 124-n measure a voltage, a current, a temperature, a remaining amount of power, a lifetime, a state of charge, etc. of the first through n-th battery trays 110-1 through 110-n. Here, the first through n-th AFEs 124-1 through 124-n may simultaneously measure monitoring data Dm.

Also, while the first through n-th AFEs 124-1 through 124-n measure monitoring data Dm, the rack BMS 200 may measure charging/discharging currents.

When measurement of monitoring data Dm is completed, the first through n-th AFEs 124-1 through 124-n convert measured data to digital data. Then, after a predetermined period of time, for example, after about 50 ms has elapsed, the first MCU 123-1 of the first tray BMS 120-1 transmits first monitoring data Dm1 to the rack BMS 200 via the first communication unit 121-1 in operation 605. Here, the rest of the tray BMSs (the second through n-th tray BMS 120-2 through 120-n) do not transmit monitoring data Dm but remain on standby.

When transmission of the first monitoring data Dm is completed, the second MCU 123-2 of the second tray BMS 120-2 transmits second monitoring data Dm2 to the rack BMS 200 via the second communication unit 121-2 in operation 607. An interval of transmission between the first monitoring data Dm1 and the second monitoring data Dm2 may be, for example, 12 ms. That is, 12 ms after the first monitoring data Dm1 may be transmitted, the second monitoring data Dm2 may be transmitted.

The monitoring data Dm up to n-th monitoring data Dmn may be transmitted at intervals as described above, in operation 609.

Accuracy of measurement of battery voltages and battery charging/discharging currents may be improved by transmission of the synchronization signal Ss and reception of the first through n-th monitoring data Dm1 through Dmn by using communication between the first through n-th tray BMSs 120-1 through 120-n and the rack BMS 200, and also, accuracy of calculation of state of charge (SOC) and state of health (SOH) may be improved.

In addition, when respectively applying the synchronization signal Ss directly to the first through n-th BMS 120-1 through 120-n, a tray BMS that is far away from the rack BMS 200, for example, the n-th tray BMS 120-n, may not recognize the synchronization signal Ss due to a decrease in voltage caused in a data line. However, as the first through n-th tray BMSs 120-1 through 120-n are serially connected and the synchronization signal Ss may be sequentially applied, reliability of the simultaneous application of the synchronization signal Ss and the monitoring data Dm may be improved.

As described above, according to the one or more of the above embodiments of the present invention, measurement accuracy of battery voltages and battery charging/discharging currents may be improved, and also, calculation accuracy of state of charge (SOC) and state of health (SOH) may be improved.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the present invention.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A battery system, comprising:
a plurality of tray battery management systems (BMSs) controlling at least one battery tray formed of a plurality of battery cells; and
a rack BMS transmitting a synchronization signal to the tray BMSs to measure monitoring data,
wherein the tray BMSs transmit the synchronization signal to a next tray BMS, measure monitoring data of the at least one battery tray via the transmitted synchronization signal, and transmit the measured monitoring data to the rack BMS.

2. The battery system of claim 1, wherein the monitoring data is related to one selected from the group consisting of a voltage, a current, a temperature, a remaining amount of power, a lifetime, and a state of charge of the at least one battery tray.

3. The battery system of claim 1, wherein the tray BMSs transmit the measured monitoring data to the rack BMS at predetermined time intervals.

4. The battery system of claim 3, wherein each of the tray BMSs comprises:
a switching unit that transmits the synchronization signal to the next tray BMS after receiving the synchronization signal;
a measuring unit that measures monitoring data of the at least one battery tray in synchronization with the received synchronization signal; and
a communication unit that transmits the measured monitoring data to the rack BMS.

5. The battery system of claim 4, wherein the switching unit is a photo-coupler.

6. The battery system of claim 1, wherein the rack BMS measures a charging/discharging current while the tray BMSs measure monitoring data of the at least one battery tray.

7. The battery system of claim 1, wherein the tray BMSs and the rack BMS performs controller area network (CAN) communication.

8. A method of controlling a battery system comprising a plurality of tray battery management systems (BMSs) controlling a plurality of battery trays formed of a plurality of battery cells; and a rack BMS controlling the plurality of tray BMSs, the method comprising:
transmitting, by the rack BMS, a synchronization signal the tray BMSs to measure monitoring data;
measuring, by the tray BMSs that have received the synchronization signal, monitoring data of the plurality of battery trays; and
transmitting the measured monitoring data to the rack BMS.

9. The method of claim 8, wherein the monitoring data is related to one selected from the group consisting of a voltage, a current, a temperature, a remaining amount of power, a lifetime, and a state of charge of the plurality of battery trays.

10. The method of claim 8, wherein in the transmitting of the synchronization signal, after a first tray BMS has received the synchronization signal, the synchronization signal is transmitted to a next tray BMS.

11. The method of claim 10, wherein the transmitting of the synchronization signal is performed by using a photo-coupler.

12. The method of claim 8, wherein in the measuring monitoring data, while the tray BMSs measure monitoring data, the rack BMS measures a charging/discharging current.

13. The method of claim 8, wherein in the transmitting of the monitoring data to the rack BMS, the tray BMSs transmit the measured monitoring data to the rack BMS at predetermined time intervals.

14. The method of claim 8, wherein the tray BMSs and the rack BMS perform controller area network (CAN) communication.

15. An energy storage system comprising a battery system, comprising:
at least one tray battery management system (BMS) controlling at least one battery tray formed of a plurality of battery cells; and
a rack BMS controlling the at least one tray BMS, and supplying power to a load by connecting power of the battery system, a generation system, and a grid,
wherein the tray BMS transmits a synchronization signal to a next tray BMS; measures monitoring data of the at least one battery tray via the transmitted synchronization signal; and transmits the measured monitoring data to the rack BMS.

16. The energy storage system of claim 15, wherein the monitoring data is related to one selected from the group consisting of a voltage, a current, a temperature, a remaining amount of power, a lifetime, and a state of charge (SOC) of the at least one battery tray.
